(19) United States
(12) Patent Application Publication
(10) Pub. No.: US 2024/0102769 A1
(43) Pub. Date: Mar. 28, 2024

(54) WATER PROJECTILES AND TOY WEAPON THEREFOR

(71) Applicants: Liran Ganor, Even Yehuda (IL); Yigal Livne, Alfei Menashe (IL)

(72) Inventors: Liran Ganor, Even Yehuda (IL); Yigal Livne, Alfei Menashe (IL)

(21) Appl. No.: 18/274,833

(22) PCT Filed: Jan. 25, 2022
(86) PCT No.: PCT/IB22/50641

§ 371 Date: Jul. 28, 2023

Related U.S. Application Data
(60) Provisional application No. 63/143,862, filed on Jan. 31, 2021.

(51) Int. Cl. F41B 7/08; A63H 27/10; F41B 9/00; F42B 6/00

(52) U.S. Cl. CPC F41B 7/08; A63H 27/10; F41B 9/00; F42B 6/00; A63H 2027/1033; F41B 7/006

(57) ABSTRACT

Apparatus includes one or more fillable containers (35) in fluid communication with a primary channel (32), which is in fluid communication with a fluid entrance opening (31) which is attachable to a fluid source. The fillable containers (35) are made of a material that ruptures upon propelling the fillable containers (35) against a target. Each of the fillable containers (35) includes a one-way valve (33) that allows fluid to flow through the primary channel (32) into a corresponding one of the containers (35) and to seal each of the containers (35) with the fluid therein.

### FIELD OF THE INVENTION

The present invention relates generally to water guns or weapons, and particularly to a water weapon that launches a water projectile and to the water projectiles used in the weapon.

### BACKGROUND OF THE INVENTION

Water guns that eject a stream of water are a well-known toy for children. These guns have been designed to eject the stream of water in a number of ways. The most common method of ejecting water has been by a manual pump coupled to the trigger of the gun. The pump is actuated by the pressure exerted by one finger of an operator upon the trigger; thus, the pump typically cannot generate enough pressure to eject the water a lengthy distance. Additionally, these types of pumps work on the actuation of a compression piston which creates single, short bursts of water.

Water guns have also been designed with small electric pumps which expel a stream of water from a tube coupled to the pump.

Toy water guns have also been developed which eject a stream of water by exerting pressure on the water within the gun greater than ambient pressure and controlling the release of water through a control valve. The water is expelled from the gun due to this pressure difference. The pressurization of the water has been achieved in a variety of manners and the pressure is high enough to eject the water a lengthy distance.

### SUMMARY

The present invention seeks to provide a novel water projectile and a novel water weapon, as is described more in detail hereinbelow. The invention uses water projectiles, that is, sachets, pouches, bags, or other compartments or containers, which are launched by the water weapon or any other method, such as being launched or thrown manually. The material of the projectile bursts or ruptures upon the projectile impacting against a person or object, thereby releasing the water from the projectile.

### BRIEF DESCRIPTION OF THE DRAWINGS

The present invention will be understood and appreciated more fully from the following detailed description taken in conjunction with the drawings in which:

FIG. 1 is a simplified pictorial illustration of a water projectile weapon, in accordance with a non-limiting embodiment of the present invention;

FIG. 2 is a simplified sectional illustration of the water projectile weapon, taken along lines B-B in FIG. 1;

FIG. 3 is a simplified top-view illustration of the water projectile weapon;

FIG. 4 is a simplified sectional illustration of the water projectile weapon, taken along lines A-A in FIG. 1;

FIG. 5 is a simplified pictorial illustration of fillable containers for use as water projectiles, in accordance with a non-limiting embodiment of the present invention;

FIGS. 6A and 6B are simplified pictorial illustrations of fillable containers for use as water projectiles, in accordance with other non-limiting embodiments of the present invention;

FIG. 6C is a simplified pictorial illustration of tearing out the fillable containers (which now become the water projectiles), and shows that the one-way valve of each water projectile remains intact, sealing the liquid inside the water projectile;

FIG. 7A is a simplified pictorial illustration of playing with the water projectiles, including filling an array of containers, carrying the array of containers, and manually throwing water projectiles at another player or other target;

FIG. 7B is a simplified pictorial illustration of the array of containers with weakened areas that cause the liquid to burst initially out of the weakened areas in a random pattern or in a particular “water bomb” pattern on another player or other target;

FIG. 7C is a simplified pictorial illustration of filling an array of containers, in which the containers contain colors or substances, such as but not limited to, sprinkles, powder, strings, threads and more;

FIG. 8A is a simplified pictorial illustration of filling the fillable containers, tearing off one of the containers for use as a water projectile, loading the water projectile into the drum magazine of the water weapon and launching the water projectile from the water weapon by pulling the trigger, in accordance with a non-limiting embodiment of the present invention;

FIG. 8B is a simplified pictorial illustration of another array of fillable containers, in accordance with another non-limiting embodiment of the present invention, in which the entire array may be inserted as a cylindrical roll array into the drum magazine of the water weapon and filled with liquid while in the drum magazine, and the water projectiles may be individually stripped (torn) from the array by the action of the carriage moving past the magazine and tearing an individual water projectile from the array which is then launched from the water weapon; and

FIG. 8C is a simplified pictorial illustration of yet another array of fillable containers, in accordance with yet another non-limiting embodiment of the present invention, in which the entire array may be inserted as an ammunition belt into the “firing chamber” of the water weapon, and the water projectiles may be individually stripped (torn) from the array by the action of the carriage moving past the belt and tearing an individual water projectile from the belt array which is then launched from the water weapon.

### DETAILED DESCRIPTION

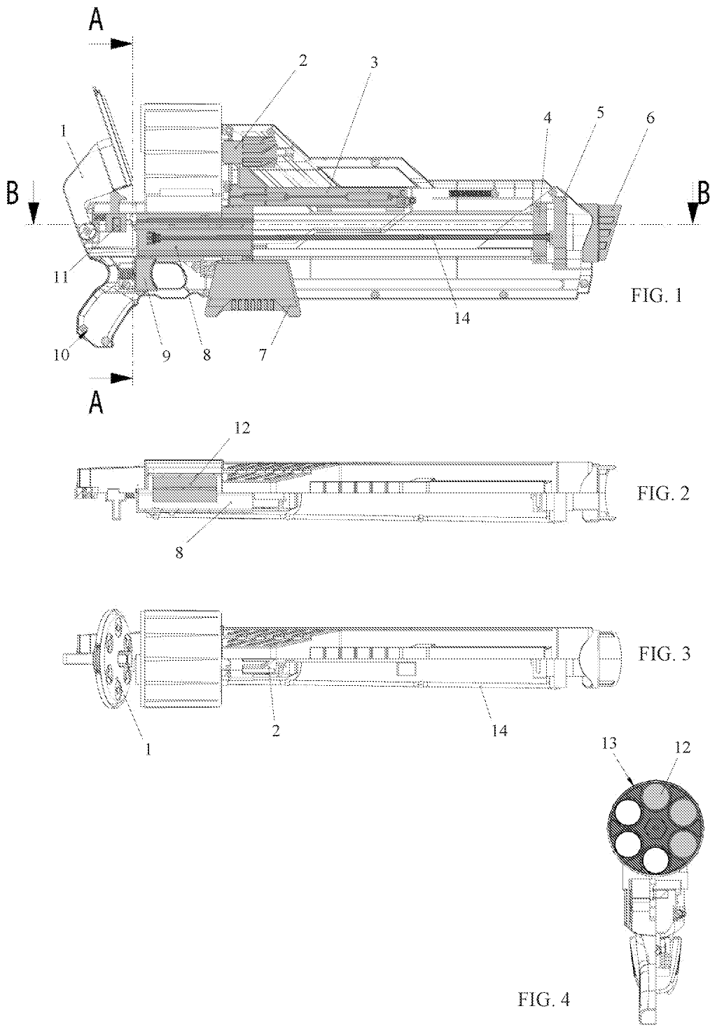

Reference is now made to FIGS. 1-4, which illustrate a water weapon, in accordance with a non-limiting embodiment of the present invention. The weapon can be in the shape of a gun, rifle, slingshot or any other weapon.

The weapon is designed to receive, handle and shoot water projectiles and includes, without limitation, a drum magazine door 1, which may be used to secure loaded water projectiles in a drum magazine 13 (also called a “compartment”). A rotation mechanism 2 may rotate the drum magazine 13, and may include a rotation trigger 3. The weapon may include an energy absorber (shock absorber) 4 and an energy absorber base 5. The weapon may include a barrel 6, a handle 7, a carriage 8 (also called a movable element), a trigger 9, a grip 10, a locking slider 11, a mechanism 13 for the drum magazine door 1, one or more water projectiles 12 and an elastic band 14.

In a non-limiting embodiment of the present invention, in the initial position of the weapon, door 1 is closed, and drum magazine 13 is not loaded with any water projectiles 12. The empty carriage 8 is at its default position close to the energy absorber 4 at the weapon's front. Elastic band 14 is in a loose position.

In order to load the water projectiles 12, the user slides the locking slider 11 to open the drum magazine door 1. The door will pop out and reveal the drum magazine 13. The user inserts the water projectiles 12 into the drum magazine 13 in their fixed position (in the illustrated embodiment, up to 6 projectiles can be loaded, but the invention is not limited to this number). After loading, the user pushes the drum magazine door 1 upwards until the locking slider 11 is locked.

After loading, the user holds the grip 10, places a finger at trigger 9 and grasps the handle 7 with the other hand.

In order to launch the water projectiles 12, the user slides the handle 7 forward to the end of barrel 6 (until it stops). At this point, handle 7 engages elastic band 14. The user then pulls the handle 7 back towards the grip 10. On the way backwards, the handle 7 gathers the carriage 8 and stretches the elastic band 14 to the end of the path. When the handle 7 reaches the end of the path, the elastic band 14 is stretched. Then squeezing trigger 9 propels the carriage 8 forward and launches the loaded water projectile 12 from the carriage 8 when the carriage reaches the end of its forward travel and stops suddenly against the energy absorber 4. The elastic band is not stretched anymore and is once again poised to be engaged by the handle 7 if the handle 7 is moved forward to the end of barrel 6. Repeating the process will launch the rest of the water projectiles 12. In this embodiment the trigger 9 is the propelling element that is coupled to the movable element 8 for propelling the fluid-sealed projectile 12 forwards from the weapon.

“Slam firing” of the water projectiles 12 is also contemplated in which the projectiles are launched from the weapon by movement of the handle 7 instead of the trigger 9. In this embodiment the handle 7 is the propelling element that is coupled to the movable element 8 for propelling fluid-sealed projectile 12 forwards from the weapon.

In this mode, handle 7 is slid forwards and backwards repeatedly after water projectiles 12 are loaded. Sliding handle 7 forwards causes the handle 7 to gather the carriage 8 from its default position. Pulling handle 7 backwards causes the elastic band 14, attached to the carriage 8, to stretch. On the way back, the carriage 8 sticks to rotation trigger 3 and pulls it backwards to trigger the rotation mechanism 2. The rotation mechanism 2 rotates and causes the drum magazine 13 to rotate.

When handle 7 is at its most backwards position, carriage 8 is located under the drum magazine 13. As drum magazine 13 rotates, two doors opens and one of the water projectiles 12 drops into the carriage 8.

Afterwards, when handle 7 starts to move forward, carriage 8 is released from the handle 7, and the attached, tensioned elastic band 14 rapidly pulls carriage 8 with the water projectile 12 inside it until the carriage 8 collides with the energy absorber 4. The sudden stopping of carriage 8 against the energy absorber 4, causes the water projectiles 12 to be propelled rapidly forwards through the barrel 6 towards the target.

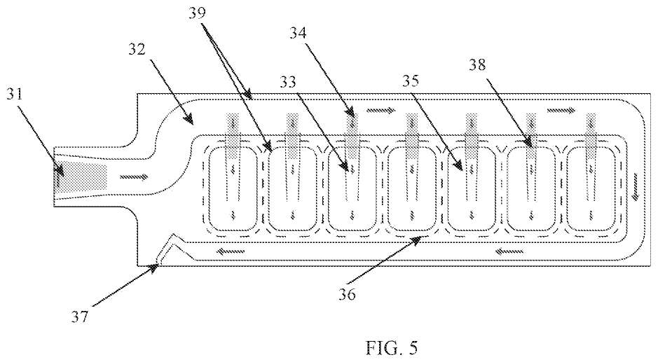

Reference is now made to FIG. 5, which illustrates fillable containers, that is, the novel water projectiles 12, for use with the weapon, in accordance with a non-limiting embodiment of the invention.

It is noted that inflatable or fillable containers such as sachets can be filled with variety of fluids, such as air, water, laundry detergent, soft drinks, etc. If individual containers were used for any game with the water projectile weapon, a lot of inflatable containers would have to be filled with fluids and sealed. The need to do multiple fillings may be time-consuming and cumbersome for the user to do.

Additionally, it is not enough to fill multiple containers; they must be properly sealed. For example, an individual may manually fill water balloons with water one at a time and then tie the balloons, but this would be time-consuming and cumbersome for the user.

The invention solves the problem of filling and sealing by providing a standalone container that can be filled and sealed.

Inflatable containers may be damaged when filled to different volumes by individuals. For example, water balloons may burst if the user does not turn off the water flow into the water balloon. The invention solves this problem with a discharge pressure valve. However, the invention can be carried out without any pressure valve.

In the invention, the fillable containers may be filled and sealed by the user at home, and there is no need for transporting filled containers from the manufacturer. If the water balloons were filled with water and sealed during the manufacturing process, they could leak or burst during transportation.

In FIG. 5, a material is formed into individual compartments. Without limitation, the material may be a continuous two-ply thermoplastic film material welded in a manner that forms superimposed panels into individual compartments.

There is an opening 31 at a first end, which may be cone shaped, which can be attached to a fluid source (e.g., faucet) as the fluid entrance. A primary channel 32 delivers the fluid to all inflatable containers at the same time.

A one-way valve 33 at each compartment allows the fluid to flow through the primary channel 32 into a corresponding inflatable container 35 and seals each container with the fluid inside. Heat resisting material 34 may be printed or otherwise placed at each valve entrance to support fluid flow into the inflatable container in lower pressures.

Separable inflatable containers 35 are designed to hold fluid while filling and handling. Cut lines 36 are placed around each inflatable container 35 to support controlled separation from the manufactured packet.

A discharge valve 37 (pressure relief valve or pressure regulator) at the second end (exit) or on an adapter at the water inlet (see below), allows controlling the filling pressure in the compartments and prevents over-pressure and bursting.

Heat resisting material 38 allows selective welding process to seal each compartment 35. The heat resisting material 38 allows welding the valve panels to the corresponding inflatable container panels and maintains the valve channel open. One example of heat resisting material 34 or 38 is heat resistant ink. Such inks are commercially available that withstand temperatures up to 300° C. for marking on plastic or shrink wrap, and they can withstand coming into contact with high temperatures of heat sealing machines, so that the ink maintains the valve channel open during welding of the valve panels to the corresponding inflatable container panels.

Welding lines 39 are the boundaries of the inflatable containers 35 and of others compartments, such as primary channel 32 and discharge valve 37.

The film material can be recycled either as a reusable or made of biodegradable plastic materials to minimize environmental damage. No additional parts or materials are required to form the apparatus other than thermoplastic film. A suitable biodegradable material is PLA (poly (lactic acid) or polylactide).

The apparatus may be filled as follows: 1. Attach and hold apparatus entrance 31 to the faucet. 2. Turn on water and fill the inflatable containers to maximum. 3. Turn off water. 4. Tear out the filled containers from the apparatus following container cut lines. The detached containers 35 become the water projectiles 12.

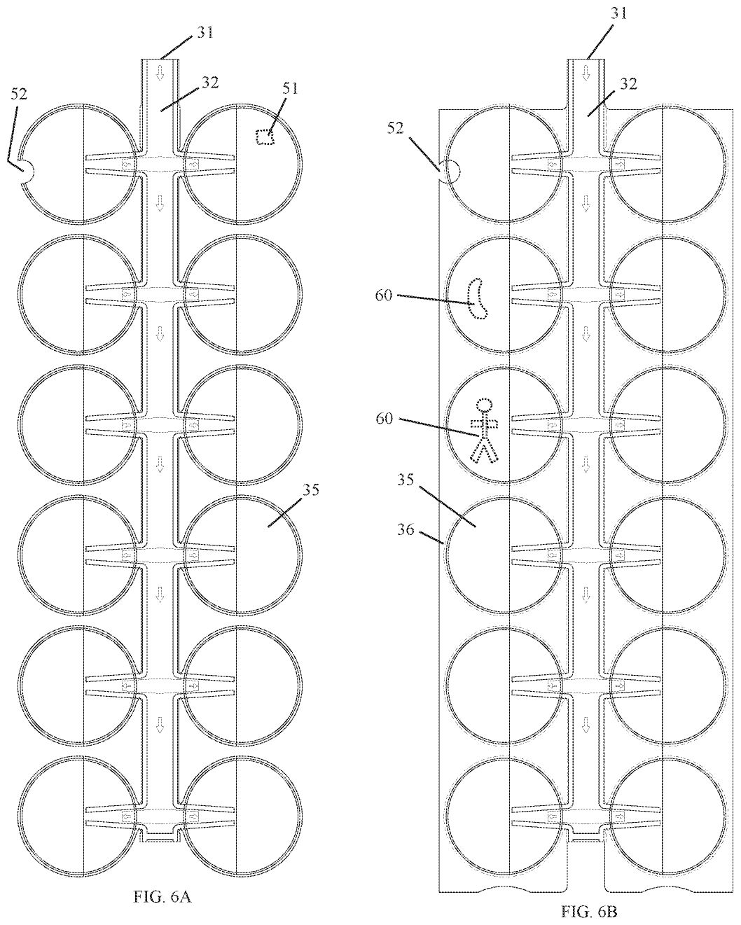

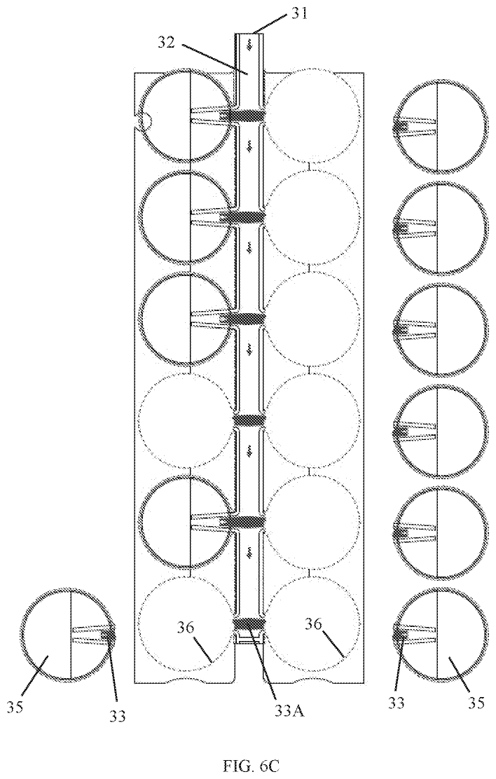

Reference is now made to FIGS. 6A and 6B, which illustrate fillable containers for use as water projectiles, in accordance with other non-limiting embodiments of the present invention. The embodiment of FIGS. 6A and 6B is similar to the embodiment of FIG. 5, and may include the same features described previously for FIG. 5 (with like elements being designated by like numerals). Accordingly, here too, there may be an opening 31 at a first end, which serves as the fluid entrance, and a primary channel 32 delivers the fluid to all inflatable containers at the same time. Separable inflatable containers 35 are designed to hold fluid while filling and handling. In FIG. 6B, as opposed to FIG. 6A, there are cut lines 36 around each inflatable container 35 to support controlled separation from the manufactured packet. In both FIGS. 6A and 6B, each container 35 may be torn away with its one-way valve 33 intact. This is particularly seen in FIG. 6C, which shows that after tearing out containers 35, each one-way valve 33 remains intact, sealing the liquid inside container 35. The one-way valve 33 is torn away from a valve branch 33A located on primary channel 32 at each row between the left and right containers 35.

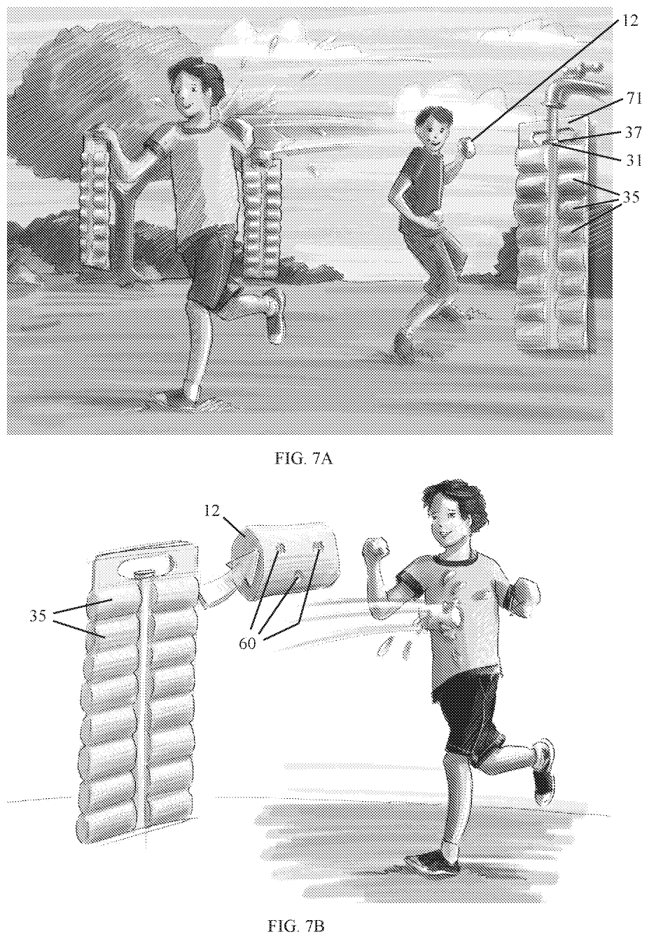

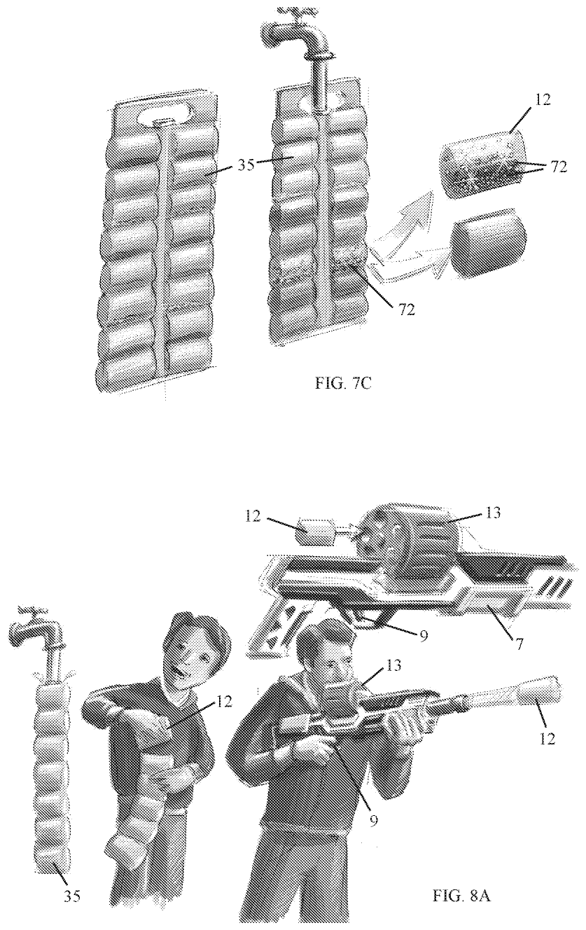

FIG. 7A is a simplified pictorial illustration of playing with the water projectiles 12, including filling an array of containers 35, carrying the array of containers 35 (the array may be formed with a handle 71), and manually throwing water projectiles 12 at another player or other target.

The embodiment of FIGS. 6A and 6B may include other features (which of course may be incorporated into the embodiment of FIG. 5) as is now explained.

As mentioned above, the array of water projectiles may include a discharge valve (pressure relief valve or pressure regulator) to control the filling pressure in the compartments and prevent over-pressure and bursting the material. In a preferred embodiment, the discharge valve 37 is on an adapter at the water inlet, as seen in FIGS. 7A-7C. Alternatively, as shown in FIG. 6A, the pressure relief valve may be in the form of a weakened-filling-pressure area of the projectile. The weakened-filling-pressure area ruptures at a lower pressure than the rest of the projectiles, so that if that weakened-filling-pressure portion bursts, only that projectile is sacrificed and the rest of the projectiles remain intact for use. The weakened-filling-pressure area may include, without limitation, an area of thinner material 51, or an interruption 52 in the outer contour of the projectile (shown in FIG. 6A), such as a concave indentation, which although being sealed or welded as the rest of the projectile, creates a stress concentration which bursts at lower pressure than the rest of the projectile.

As mentioned above, the material of the projectile bursts or ruptures upon the projectile impacting against a person or object, thereby releasing the water from the projectile. Accordingly, in another aspect of the invention, the projectile may include one or more weakened-impact-pressure areas 60 (shown in FIG. 6B), which provide preferred areas for the water projectile to rupture upon impact with the desired target. The weakened-impact-pressure areas 60 may be placed randomly or in a pattern so as to create a particular “spray pattern” on the target.

This option is shown in FIG. 7B, which illustrates the array of containers with weakened areas 60 that cause the liquid to burst initially out of the weakened areas 60 in a random pattern or in a particular “water bomb” pattern on another player or other target. In a preferred embodiment, just the weakened areas 60 burst and the rest of the projectile remains intact. This is advantageous because it simplifies gathering the spent projectiles from the lawn or other environmental area, instead of having to gather small debris if the entire projectile were to burst into small pieces.

The weakened-impact-pressure area 60 may include, without limitation, an area of thinner material or burst lines made of weaker welding or other joining means. Other options include, without limitation, using different types of joining or welding to create weaker or stronger areas, or exposing the projectile bag material to electromagnetic radiation or chemicals to modify the strength of the material. Strengthening elements may be added to the projectile material, such as but not limited to, areas or strips of stronger or thicker material added to the projectile material.

Another option is to add into the liquid that fills the projectiles different colors or substances (e.g., glitter or powder and others) that create different effects when the projectile bursts on the target. This option is shown in FIG. 7C, which illustrates filling an array of containers, in which the containers contain colors or substances 72, such as but not limited to, sprinkles, powder, beads, pellets, strings, threads and more.

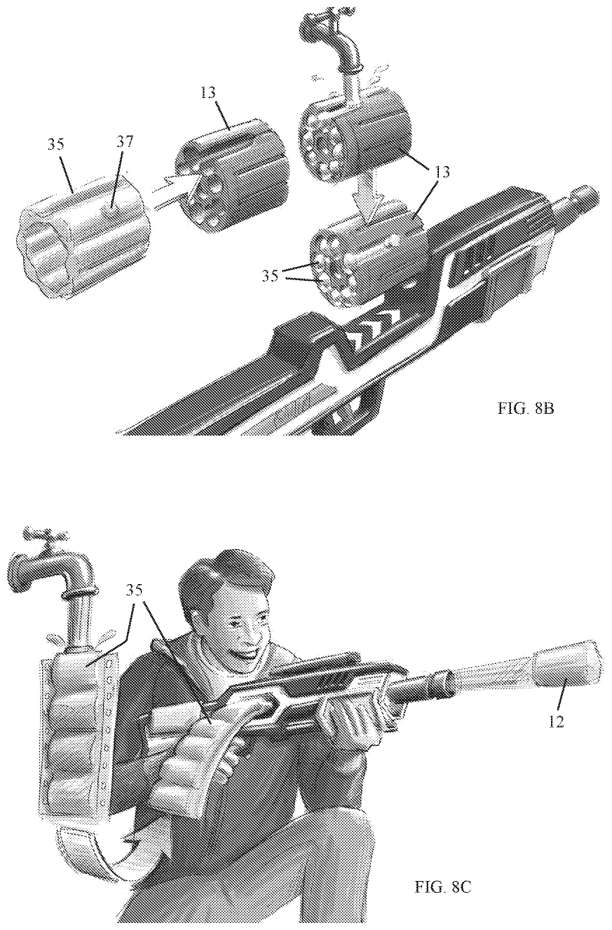

Using the combination of the water projectiles and water weapon is shown in FIGS. 8A-8C.

Reference is now made to FIG. 8A, which illustrates filling the fillable containers 35, tearing off one of the containers for use as a water projectile 12, loading the water projectile 12 into the drum magazine 13 of the water weapon and launching the water projectile 12 from the water weapon by pulling the trigger 9.

Reference is now made to FIG. 8B, which illustrates another array of fillable containers 35, in accordance with another non-limiting embodiment of the present invention. Here the entire array may be inserted as a cylindrical roll array into the drum magazine 13 of the water weapon and filled with liquid while in the drum magazine 13. The water projectiles may be individually stripped (torn) from the array by the action of the carriage moving past the magazine and tearing an individual water projectile from the array which is then launched from the water weapon.

Reference is now made to FIG. 8C, which illustrates yet another array of fillable containers 35, in accordance with yet another non-limiting embodiment of the present invention. Here the entire array may be inserted as an ammunition belt into the “firing chamber” (also called the “compartment”) of the water weapon, and the water projectiles 12 may be individually stripped (torn) from the belt array by the action of the carriage moving past the belt array and tearing an individual water projectile from the belt array which is then launched from the water weapon.

1. An apparatus, comprising:
one or more fillable containers (35) in fluid communication with a primary channel (32), said primary channel (32) being in fluid communication with a fluid entrance opening (31) which is attachable to a fluid source, said one or more fillable containers (35) being made of a material that ruptures upon propelling said one or more fillable containers (35) against a target;
each of said one or more fillable containers (35) comprising a one-way valve (33) configured to allow fluid to flow through said primary channel (32) into a corresponding one of said one or more fillable containers (35) and to seal each of said one or more fillable containers (35) with the fluid therein.

2. The apparatus according to claim 1, wherein cut lines (36) are formed in said material at boundaries of said one or more fillable containers (35) so that said one or more fillable containers (35) are individually separable with the fluid therein.

3. The apparatus according to claim 1, further comprising a pressure relief valve (37) in fluid communication with said one or more fillable containers (35).

4. The apparatus according to claim 1, wherein the fluid is flowable via said primary channel (32) simultaneously to all of said one or more fillable containers (35).

5. The apparatus according to claim 1, wherein said one or more fillable containers (35) and said cut lines (36) are formed from a continuous film material.

6. The apparatus according to claim 2, wherein after tearing out said one or more fillable containers (35), each said one-way valve (33) remains intact, sealing liquid inside said one or more fillable containers (35).

7. The apparatus according to claim 6, wherein each said one-way valve (33) is torn away from a valve branch (33A) located on said primary channel (32).

8. The apparatus according to claim 1, wherein said one or more fillable containers (35) contain colors or substances (72).

9. The apparatus according to claim 1, wherein said one or more fillable containers (35) comprises weakened areas (60) that cause the fluid to burst initially out of said weakened areas (60).

10. An apparatus, comprising:
a weapon comprising a movable element (8) for receiving therein a fluid-sealed projectile (12) that is sealed with fluid therein, a propelling element (7, 9) coupled to said movable element (8) for propelling said fluid-sealed projectile (12) forwards from said weapon, and a compartment (13) for receiving therein said fluid-sealed projectile (12), said compartment (13) comprising an exit from which said fluid-sealed projectile (12) leaves said compartment (13) and enters said movable element (8), wherein a force of said movable element (8) that propels said fluid-sealed projectile (12) forwards from said weapon is insufficient to rupture said fluid-sealed projectile (12).

11. The apparatus according to claim 10, wherein said compartment (13) is rotatable.

12. The apparatus according to claim 10, further comprising a stop (4) against which said movable element (8) is abuttable.

13. The apparatus according to claim 10, wherein movement of said movable element (8) past said compartment (13) strips said fluid-sealed projectile (12) from an array of projectiles (12) for launching from said weapon.
